(19) United States
(12) Patent Application Publication
(10) Pub. No.: US 2009/0071211 A1
(43) Pub. Date: Mar. 19, 2009

(54) CABLE SEAL LOCK

(75) Inventors: Robert E. Stone, Upland, IN (US); Patrick A. Kumfer, Wolcottville, IN (US); David A. Franks, Coldwater, MI (US); Jeffrey E. Warner, Chester, VA (US)

Correspondence Address: BAKER & DANIELS LLP, 202 South Michigan Street, Suite 1400, South Bend, IN, 46601, US

(73) Assignee: E. J. Brooks Company, Angola, IN (US)

(21) Appl. No.: 11/855,420

(22) Filed: Sep. 14, 2007

(51) Int. Cl. E05B 63/00

(52) U.S. Cl. 70/451

(57) ABSTRACT

A cable seal lock assembly including a housing having a top end and a bottom end with at least two openings in each end. A generally cylindrical-shaped cable sleeve is located in the housing and has a bore therethrough, and ends of the bore are aligned with respective openings in the top and bottom ends of the housing. A clip sleeve is located at least partially within the housing and has a bore of non-uniform diameter extending therethrough, and one end of the clip sleeve extends through one of the openings in the top end of the housing, with the bore at the other end of the clip sleeve aligned with one of the openings at the bottom end of the housing. A locking clip is located in the clip sleeve, and a backing plate is located in the housing with holes that are aligned with the openings at one end of the housing.

### BACKGROUND OF THE INVENTION

This invention relates to a cable seal lock, and in particular, to a cable seal lock including a molded cover, a locking clip, and a clip sleeve which prevent a cable from being pulled from the cable seal lock without breakage or showing evidence of tampering.

Locking devices and security devices are generally known and widely used. For example, one prior art locking device includes a serpentine gripping member used to lock a cable is disclosed in U.S. Pat. No. 5,582,447 to Leon et al The locking device includes a serpentine-shaped wire clip that is placed around the cable and inserted into a tapered bore of a housing. As the wire is pulled through the housing toward the small end of the tapered bore, the bore presses the wire clip firmly on the cable to lock the cable therein. The housing also includes a flanged closure to prevent the wire clip from coming out of the bore. Various embodiments are disclosed for the wire clip.

U.S. Pat. Nos. 6,540,273 B2 and 6,948,746 B2 to Brammall et al. disclose a security seal and lock with an enhanced bore sleeve. The security seal utilizes a clip similar to that disclosed by Leon et al. and further includes a locking collet or sleeve, wherein the wire clip is located. As the collet/sleeve is pulled forward, it forces the clip tightly about a cable to lock the cable in position. The housing in Brammall et al. includes two chambers, one in which the collet/sleeve and wire clip are located, and another chamber wherein the cable end is secured by swagging or stapling thereto through openings in a side of the housing.

### SUMMARY OF THE INVENTION

In one embodiment of the invention, a cable seal lock assembly is provided that includes a housing having a top end and a bottom end with at least two openings in each end, and at least one of the openings in the top end being larger than the openings in the bottom end. A generally cylindrical-shaped cable sleeve is located in the housing that has a bore therethrough, and ends of the bore are aligned with respective openings in the top and bottom ends of the housing. A clip sleeve is located at least partially within the housing and has a bore of non-uniform diameter extending therethrough, and one end of the clip sleeve extends through the larger opening in the top end of the housing, with the bore at the other end of the clip sleeve aligned with one of the openings at the bottom end of the housing. A locking clip is located in the clip sleeve, the locking clip has an outer diameter that is smaller at one end of the locking clip than at the other end, and a backing plate is located in the housing and has two holes therethrough so that the holes are aligned with the openings at one end of the housing.

The clip sleeve may include an extension extending around the bore at the end of the clip sleeve that extends out of the housing. The extension is bendable to prevent the locking clip from coming out of the bore of the cable sleeve, and the clip sleeve and the cable sleeve may be substantially parallel to one another. The backing plate may be oriented substantially perpendicular to the cable sleeve and the clip sleeve, and the backing plate may be located between one end of the housing and the cable sleeve and the clip sleeve.

The locking clip may have a generally open-ended, cage-like shape configured to receive a cable therethrough. The cage-like shape may be defined by a generally serpentine configuration. The inner surface of the locking clip may include protrusions running substantially perpendicular to a longitudinal axis of the clip, to assist in clamping a cable extending therethrough. The locking clip may include extensions extending from the serpentine configuration that extend substantially parallel to the longitudinal axis of the locking clip. The extensions may be located at the end of the locking clip having the smaller diameter, and the smaller diameter end is more inwardly flexible than the larger diameter end. The protrusions may be located in the extensions of the locking clip.

The housing may have a front side and a back side, wherein the front side includes an elongated opening, and the back side includes a pair of openings aligned with the elongated opening to provide means to stake or swag the cable in the housing against an external backing.

In another embodiment of the invention, a cable seal lock assembly is provided that includes a housing having a top end and a bottom end with at least two openings through each end, a clip sleeve located at least partially within the housing and having a bore of non-uniform diameter extending therethrough, and a locking clip located in the clip sleeve. The locking clip has an outer diameter that is smaller at one end of the locking clip than at the other end and has a generally open-ended, cage-like shape that is configured to receive a cable therethrough. The cage-like shape can be defined by a generally serpentine configuration with extensions extending from the serpentine configuration substantially parallel to a longitudinal axis of the locking clip, and the protrusions are located in the extensions and extend around an inner surface of the clip.

The extensions may be located at the smaller diameter end of the locking clip, and the smaller diameter end may have a greater inward flexibility than the larger diameter end. The clip sleeve may extend through one of the openings in the top end of the housing, and at the other end of the clip sleeve, the bore is aligned with one of the openings in the bottom end of the housing. The opening in the top end of the housing that the clip sleeve extends through may be larger than the openings in the bottom end, and the clip sleeve may include an extension about the bore at the end of the cable sleeve extending out of the housing, wherein the extension is bendable to prevent the locking clip in the bore of the cable sleeve from coming out of the bore when the cable is inserted.

The cable seal lock assembly may further include a cable sleeve located in the housing and having a bore therethrough, with ends of the bore being aligned with respective openings in the top and bottom ends of the housing. The cable sleeve may be substantially parallel to the clip sleeve. The cable seal lock assembly may further include a backing plate located in the housing between the bottom end and the cable sleeve and clip sleeve. The backing plate has at least two holes therethrough, with the holes aligned with the openings at the bottom end of the housing. The backing plate may also be substantially perpendicular to the cable sleeve and clip sleeve.

In another embodiment of the invention, a cable seal lock assembly is provided that includes a housing having a top end and a bottom end with at least two openings in each end, a cable sleeve located in the housing, and having a bore therethrough, and ends of the bore aligned with respective openings in the top and bottom ends of the housing, a clip sleeve located at least partially within the housing and having a bore of non-uniform diameter extending therethrough, the bore at one end of the clip sleeve aligned with one of the openings at the bottom end of the housing, and a locking clip located in the clip sleeve. The locking clip may be configured to receive a cable therethrough. The cable seal lock assembly may also include a backing plate located in the housing between the bottom end and the cable sleeve and clip sleeve. The backing plate has at least two holes therethrough that are aligned with the openings at one end of the housing and respective bores in the cable sleeve and clip sleeve.

The cable sleeve and clip sleeve may be substantially parallel to one another. The backing plate may be oriented substantially perpendicular to the cable sleeve and clip sleeve. At least one of the openings in the top end of the housing may be larger than the openings in the bottom end of the housing, and the clip sleeve may extend through the larger opening. The clip sleeve may include an extension about the end thereof that extends out of the housing. The extension is bendable to prevent the locking clip from coming out of the bore of the clip sleeve when a cable is inserted.

The locking clip may have a generally serpentine configuration and extensions extending from the serpentine configuration that run substantially parallel to a longitudinal axis of the clip. Protrusions around the inner surface of the locking clip may be located in the extensions, and the end of the locking clip with the extensions may be more inwardly flexible than the other end.

### BRIEF DESCRIPTION OF THE DRAWINGS

The above-mentioned and other features and objects of this invention and the manner of obtaining them will become more apparent and the invention itself will be better understood by reference to the following description of embodiments of the present invention taken in conjunction with the accompanying drawings, wherein:

FIG. 1 is a perspective view of one embodiment of the present invention of a cable seal lock assembly with one end of a cable staked in the assembly;

FIG. 2 is a side view of the cable seal lock assembly and cable of FIG. 1;

FIG. 3 is a bottom view of the cable seal lock assembly and cable of FIG. 1;

FIG. 4 is a cross-sectional view of the cable seal lock assembly and cable of FIG. 1 taken along line 4-4 of FIG. 3;

FIG. 4A is a cross-sectional view of the cable seal lock assembly and cable of FIG. 1 taken along line 44 of FIG. 3 showing the cable threaded through and locked into a lock body of the assembly;

FIG. 5 is a front perspective view of one embodiment of a housing for the cable seal lock assembly of FIG. 1;

FIG. 6 is a back perspective view of the other end of the housing of FIG. 5;

FIG. 7 is a side view of the housing of FIG. 5;

FIG. 8 is a perspective view of one embodiment of a locking clip for use in the cable seal lock assembly of FIG. 1;

FIG. 9 is a perspective view taken from the other end of the locking clip of FIG. 8;

FIG. 10 is an end view of the locking clip of FIG. 8;

FIG. 11 is a cross-sectional view of the locking clip of FIG. 8 taken along line 11-11 of FIG. 10;

FIG. 12 is a perspective view of one embodiment of a clip sleeve for use with the locking clip and cable seal lock assembly of FIG. 1;

FIG. 13 is a perspective view of the clip sleeve of FIG. 12 from the other end thereof;

FIG. 14 is a side view of the clip sleeve of FIG. 12;

FIG. 15 is a cross-sectional view of the clip sleeve of FIG. 12 taken along line 15-15 of FIG. 14 and including an extension about the bore at one end thereof;

FIG. 15A is a cross-sectional view of the clip sleeve of FIG. 12 taken along line 15-15 of FIG. 14 with the ends of the extension crimped in;

FIG. 16 is a perspective view of one embodiment of a cable sleeve for the cable seal lock assembly of FIG. 1;

FIG. 17 is an end view of the cable sleeve of FIG. 16;

FIG. 18 is a perspective view of one embodiment of a backing plate for the cable seal lock assembly of FIG. 1; and

FIG. 19 is a plan view of the backing plate of FIG. 18.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings, which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates.

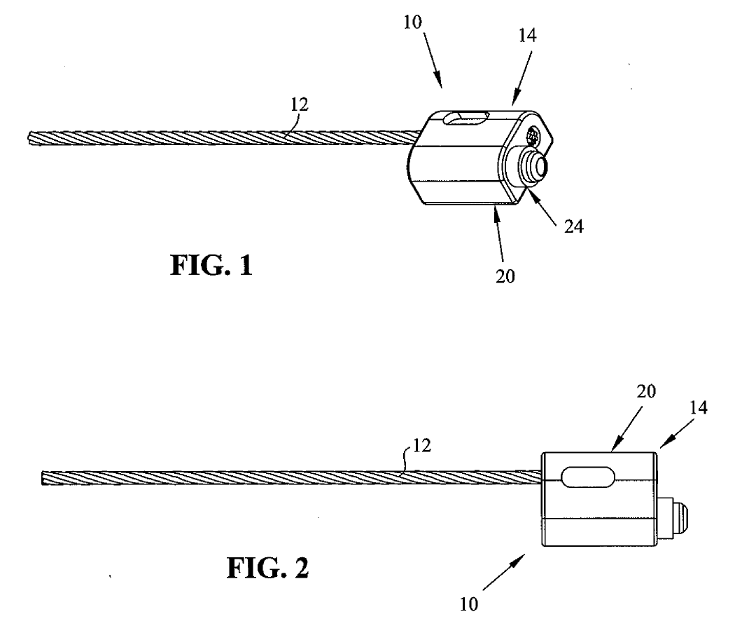

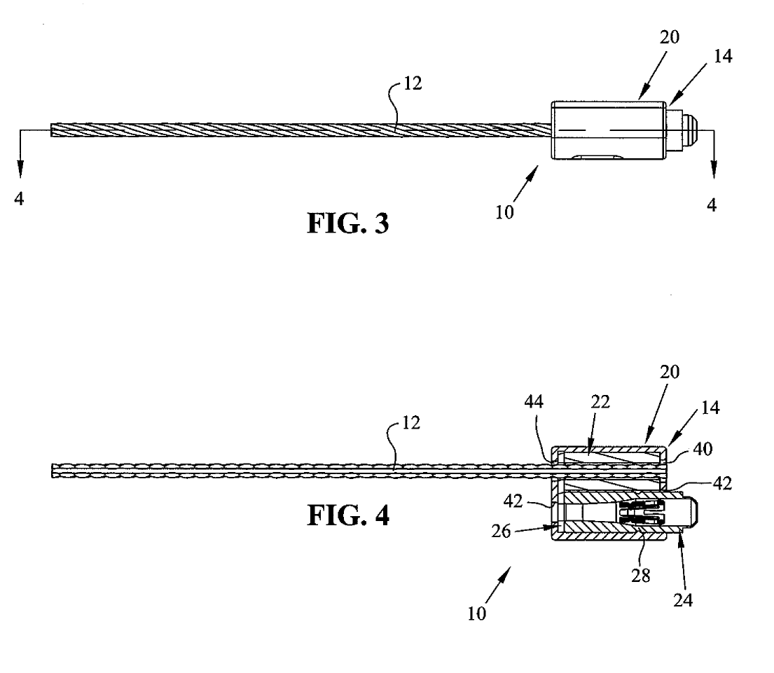

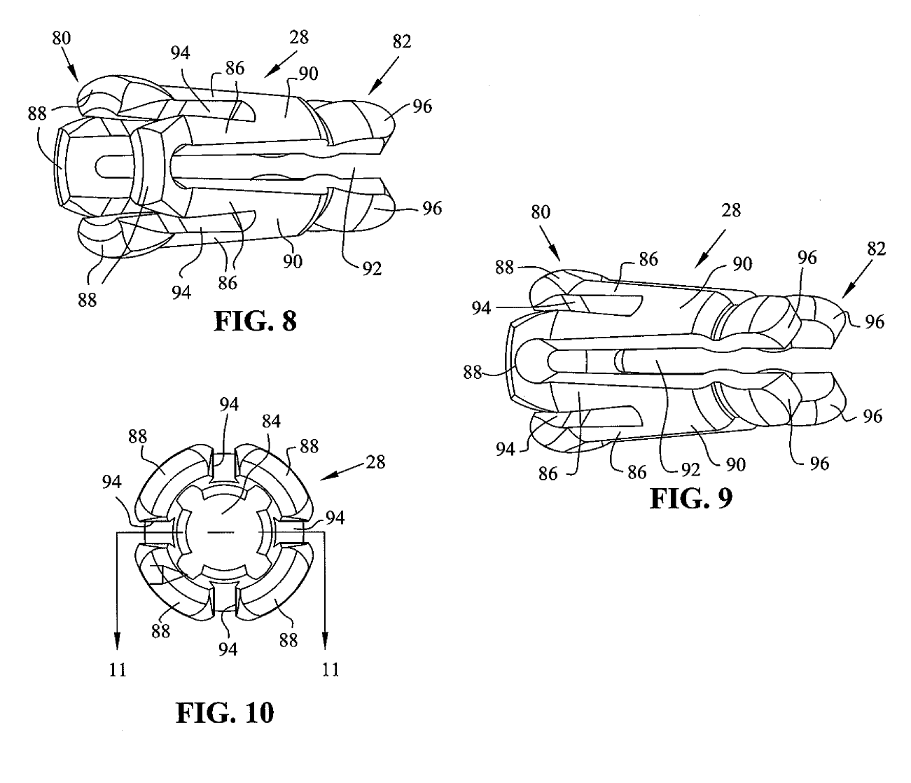

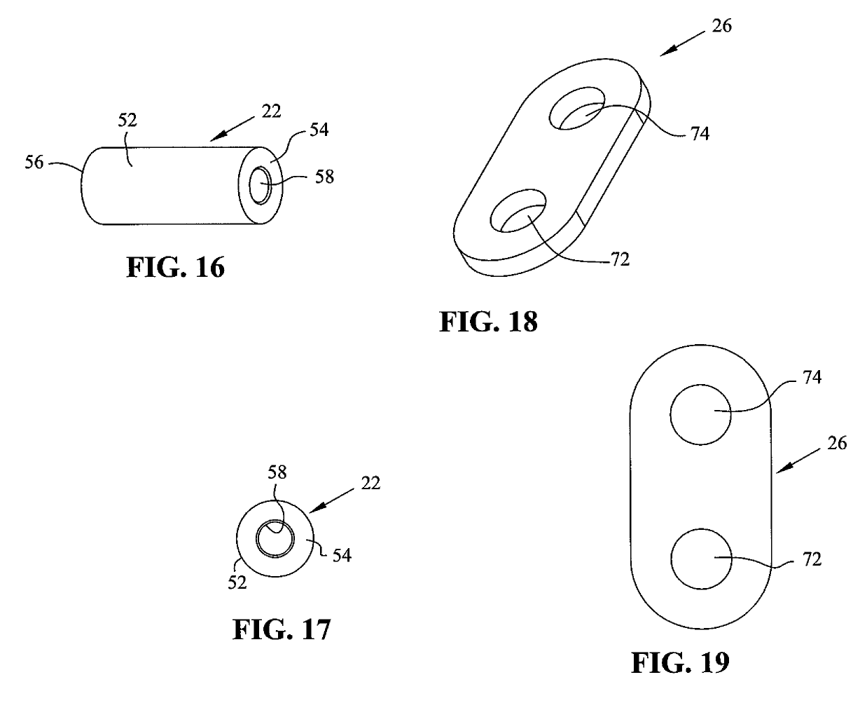

Referring first to FIGS. 1-4, a cable seal lock assembly is shown, generally indicated as 10. Cable seal lock assembly 10 includes a shackle 12, which is typically a solid or stranded steel cable, and a lock body, generally indicated as 14. Together, shackle/cable 12 and lock body 14 are used to seal and/or lock a hasp or other securing mechanism of a door to seal and/or lock and prevent entry into the cargo hold of a truck, shipping container, or other device for shipping or storing goods, as is known. Lock body 14 includes a housing, generally indicated as 20 (FIG. 5), a cable sleeve, generally indicated as 22 (FIG. 16), a clip sleeve, generally indicated as 24 (FIG. 12), a backing plate, generally indicated as 26 (FIG. 18), and a locking clip, generally indicated as 28 (FIGS. 8-11).

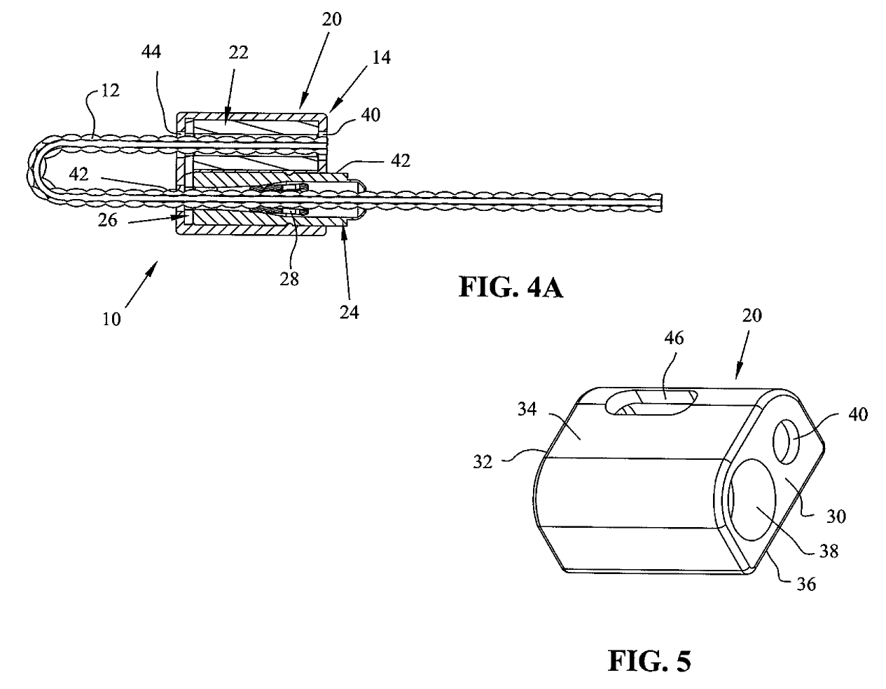

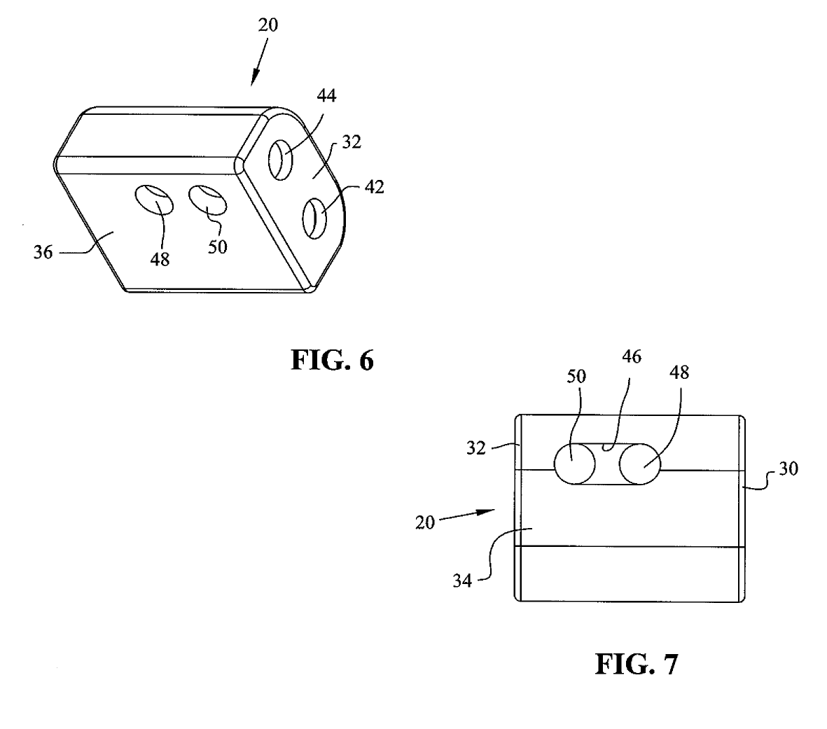

In the embodiment shown in FIGS. 4-7, housing 20 defines a generally hollow cavity, wherein cable sleeve 22, clip sleeve 24, backing plate 26, and locking clip 28 are primarily located. Housing 20 includes a top end 30, a bottom end 32, a front side 34, and a back side 36. Top end 30 includes at least two openings 38, 40 contained therethrough extending into the interior cavity, and wherein in the embodiment shown, opening 38 is larger than opening 40. The bottom end 32 also includes at least two openings 42, 44, extending therethrough into the cavity, and wherein in the embodiment shown, openings 42 and 44 are approximately the same size. Opening 40 in top end 30 is aligned along a common axis with opening 44 in bottom end 32, and opening 38 in top end 30 is aligned along a common axis with opening 42 in bottom end 32, as best shown in FIG. 4.

Front side 34 of housing 20 has curved or radiused longitudinal edges in the embodiment shown, and a slot or elongated opening 46 extending therethrough into the interior cavity of housing 20. Back side 36 is substantially flat, and includes two openings 48, 50 extending therethrough into the interior cavity of housing 20. The ends of elongated opening 46 in front side 34 are substantially aligned with openings 48 and 50 in back side 36, as best shown in FIG. 7. Housing 20 may be made from a plastic-type material, which will readily show evidence of tampering by someone trying to remove shackle 12, or it may be made from metals as is known, such as zinc. The body may be molded in the desired configuration, wherein one of the top or bottom ends or back side is welded or attached with adhesive after the other components have been installed inside, as discussed in further detail below.

Now referring to FIGS. 16 and 17, cable sleeve 22 has a generally cylindrical configuration, including an exterior surface 52, a top end 54, and a bottom end 56. Cable sleeve 22 also has a bore 58 of uniform diameter extending completely therethrough along a central axis of the sleeve and which is open at both top end 54 and bottom end 56. The cable sleeve is made from a deformable material and may be made from a metal, such as steel or aluminum, for purposes discussed below.

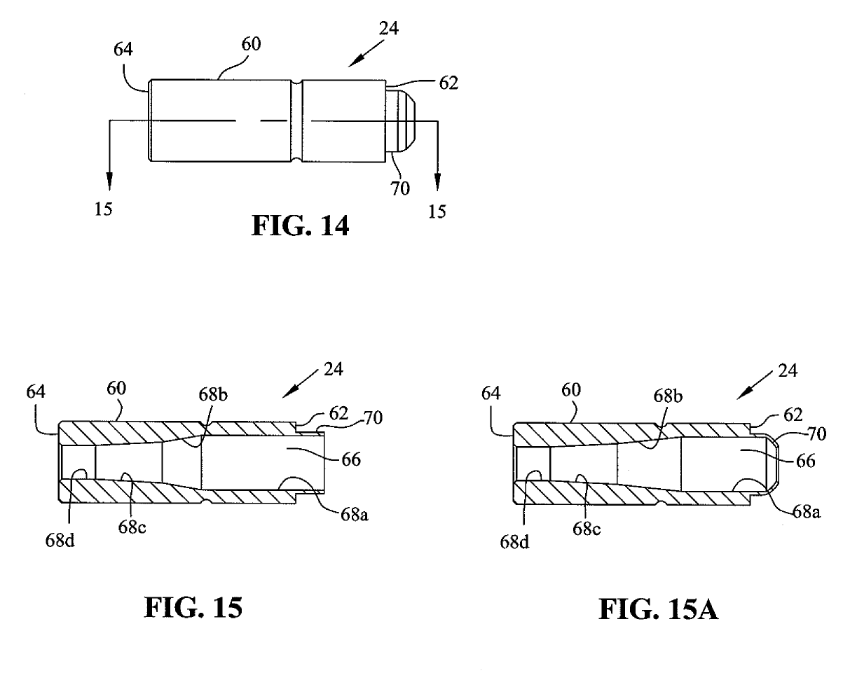

Now referring to FIGS. 12-15, clip sleeve 24 also has a generally cylindrical configuration including an exterior surface 60, a top end 62, a bottom end 64, and a bore 66 of non-uniform diameter extending centrally through the clip sleeve along a longitudinal axis thereof. Bore 66 includes a first portion 68a of uniform diameter, a second truncated portion 68b, a third portion 68c having a more gradual taper than portion 68b, and a fourth portion adjacent bottom end 64, wherein the diameter of bore 66 is smallest, as best shown in FIGS. 15 and 15A. Clip sleeve 24 also includes an extension 70 extending about bore 66 at top end 62.

Extension 70 may be crimped or bent inwardly to reduce the diameter of bore 66, as shown in FIG. 15A, to prevent locking clip 28 from becoming dislodged from the bore once inserted therein. The clip sleeve may be a metallic tube and portion 68d of bore 66 is sized to receive shackle 12 therethrough. The size of the bore portion 68a at top end 62 is designed to receive the locking clip therein. As noted, bore 66 is tapered in two steps in portions 68b and 68c. In one embodiment, the taper in portion 68c is 6°, but of course other angles may be used. In portion 68c, the bore tapers from the largest diameter in portion 68a into the locking taper of 6° in 68c using a larger included angle than the locking taper. In one embodiment, the clip sleeve is made from steel, although other materials may be employed.

Backing plate 26, as shown in FIGS. 18 and 19, has a generally planar-type configuration and is rounded on both ends. Furthermore, backing plate 26 is configured to be placed transversely to the cross section of housing 20 shown in FIG. 4. Backing plate 26 also includes a pair of openings 72 and 74 extending therethrough. Holes 72 and 74 are sized to receive a length of shackle 12 therethrough. In addition, holes 72, 74 are placed so as to line up with holes to the cable sleeve and clip sleeve when the components are assembled within housing 28. The backing plate may be made from steel or other suitable materials.

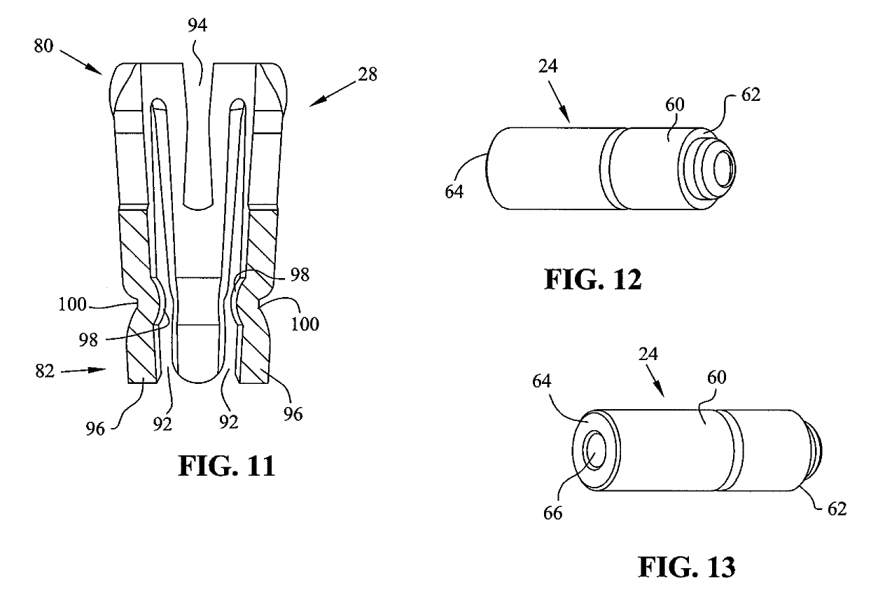

Now referring to FIGS. 8-11, locking clip 28 is shown in greater detail. As can best be seen in FIGS. 8 and 9, locking clip 28 has a generally cage-like shape that is defined by a generally serpentine configuration. Locking clip 28 includes a larger diameter end, generally indicated as 80, and a smaller diameter end, generally indicated as 82. An opening 84 extends through locking clip 28, as best shown in FIG. 10, opening 84 being sized and configured to receive shackle 12 therethrough. The cage-like serpentine configuration is defined by generally longitudinal sections 86 that are connected at end 80 by cross portions 88, and are connected by cross portions 90 towards end 82. Additionally, defined between longitudinal sections 86, locking clip 28 includes longitudinal slots 92, which are open at end 82 and closed by cross portions 88 at end 80, and longitudinal slots 94 that are open at large diameter end 80 and closed at the opposite end by cross portions 90. In addition, locking clip 28 includes extensions 96 extending from cross portions 90 at the smaller diameter end 82. It should be appreciated that although locking clip 28 has four extensions in the embodiment depicted, more or fewer extensions may be employed. Locking clip 28 also includes protrusions/dimples 98 (see FIG. 11) extending from extensions 96 into opening 84 to assist in engaging shackle 12, as discussed in further detail below. On the exterior portion of locking clip 28 adjacent extensions 96 are indentations 100.

In one embodiment, the locking clip is made from steel and formed by stamping out the configuration depicted. It should be realized that the protrusion/dimple may extend across the length of each extension or may be merely a rounded protrusion. In addition, the protrusions are shown on all of the extensions; however, they may be limited to one or more legs.

To assemble cable seal lock assembly 10, a cable sleeve 22, a clip sleeve 24, and backing plate 26 are inserted into an open end or back of the housing 20. Alternately, the components may be over molded in a plastic injection molding process that creates the housing around the components. Before or after the clip sleeve is contained in housing 20, locking clip 28 is inserted into bore 66 of clip sleeve 24 in end 62 of the locking clip. The smaller diameter end of locking clip 28 is inserted first so that the larger diameter end 80 is closer to top end 62 of clip sleeve 24. The locking clip is inserted in bore 66 while extension 70 extends outward, as shown in FIG. 15. Once the locking clip is inserted in the bore, extension 70 may be crimped, as shown in FIG. 15A, to contain locking clip 28a within bore 66.

Once the clip sleeves and backing plate are in place in the housing, one end of shackle 12 is inserted into cable sleeve 22 through opening 44 in housing 20. The shackle may also extend out the other end of the cable sleeve and out opening 40, if desired. The shackle 12 is staked to the cable sleeve by placing a backing support against the cable sleeve through slot 46 and then inserting stakes through openings 48 and 50 to crimp the cable in the cable sleeve without damaging the plastic cover. As should be appreciated, openings 48, 50 and slot 46 are centered over the long axis of the cable sleeve and located directly opposite each other to facilitate crimping the cable in the sleeve. It should be appreciated that, if a plastic cover is used and a backing support is not supplied through slot 46, the housing may be damaged in the staking process.

To use cable seal lock assembly 10, the end of shackle 12 not staked into the cable sleeve is inserted through a hasp of a door or other hardware (not shown), as is known, that it is desired to lock and/or provide a seal to indicate if someone has attempted to open the door. Shackle 12 is then inserted through opening 42 of housing 20 and into bore 66 of clip sleeve 24, and further passing through bore 84 in locking clip 28. Shackle 12 is freely admitted through bores 66 and 84 in this direction; however, the cable seal lock 10 will lock up and prevent the cable from being pulled back out of opening 42. The cable is locked in lock body 14 by locking clip 28 clamping down upon shackle 12 as extensions 96 and end 82 of the locking clip are drawn into locking diameter 68c of bore 66. This is accomplished by protrusions 98 and being embedded in shackle 12 as shown in FIG. 4A, and as the cable is pulled to the left, the locking taper forces locking clip 28 inward and into an even greater locking engagement with shackle 12. Once locked down thusly, shackle 12 cannot be pulled from lock body 14. Accordingly, to remove lock assembly 10 from the hasp or other hardware to which it has been attached, shackle 12 must be cut or housing 20 must be destroyed. It should be appreciated that based upon the configuration and extensions extending from end 82 of locking clip 28, the smaller diameter end 82 is more flexible and compressible than larger diameter end 80, thereby facilitating drawing the locking clip 28 into the locking diameter 68c of bore 66 as end 82 is inserted first into bore 66, as discussed above.

While the invention has been taught with specific reference to these embodiments, one skilled in the art will recognize that changes can be made in form and detail without departing from the spirit and scope of the invention. The described embodiments are to be considered, therefore, in all respects only as illustrative and not restrictive. As such, the scope of the invention is indicated by the following claims rather than by the description.

1. A cable seal lock assembly including:
a housing, the housing having a top end and a bottom end with at least two openings in each end, and at least one of the openings in the top end being larger than the openings in the bottom end;
a generally cylindrical-shaped cable sleeve located in the housing and having a bore therethrough, and ends of the bore aligned with respective openings in the top and bottom ends of the housing;
a clip sleeve located at least partially within the housing and having a bore of non-uniform diameter extending therethrough, one end of the clip sleeve extending through the larger opening in the top end of the housing, with the bore at the other end of the clip sleeve aligned with one of the openings at the bottom end of the housing;
a locking clip located in the clip sleeve, the locking clip having an outer diameter that is smaller at one end of the locking clip than at the other end; and
a backing plate located in the housing and having two holes therethrough, the holes aligned with the openings at one end of the housing.

2. The cable seal lock assembly as set forth in claim 1, wherein the clip sleeve includes an extension about the bore at the end of the clip sleeve extending out of the housing, the extension being bendable to prevent the locking clip from coming out of the bore of the clip sleeve when a cable is inserted through the locking clip.

3. The cable seal lock assembly as set forth in claim 1, wherein the clip sleeve and the cable sleeve are substantially parallel to one another.

4. The cable seal lock assembly as set forth in claim 3, wherein the orientation of the backing plate is substantially perpendicular to the cable sleeve and the clip sleeve.

5. The cable seal lock assembly as set forth in claim 4, wherein the backing plate is located between one end of the housing and the cable sleeve and the clip sleeve.

6. The cable seal lock assembly as set forth in claim 1, wherein the locking clip has a generally open-ended, cage-like shape configured to receive a cable therethrough.

7. The cable seal lock assembly as set forth in claim 6, wherein the cage-like shape is defined by a generally serpentine configuration.

8. The cable seal lock assembly as set forth in claim 7, including protrusions around the inner surface of the locking clip, the protrusions running substantially perpendicular to a longitudinal axis of the clip, and assisting in clamping a cable extending therethrough.

9. The cable seal lock assembly as set forth in claim 8, wherein the locking clip includes extensions extending from the serpentine configuration substantially parallel to the longitudinal axis of the locking clip.

10. The cable seal lock assembly as set forth in claim 9, wherein the extensions are located at the end of the locking clip having the smaller diameter, and the smaller diameter end is more inwardly flexible than the larger diameter end.

11. The cable seal lock assembly as set forth in claim 10, wherein the protrusions are located in the extensions of the locking clip.

12. The cable seal lock assembly as set forth in claim 1, wherein the housing has a front side and a back side, the front side including an elongated opening, the back side including a pair of openings aligned with the elongated opening to provide means to stake the cable in the housing against an external backing.

13. A cable seal lock assembly including:
a housing having a top end and a bottom end with at least two openings through each end;
a clip sleeve located at least partially within the housing and having a bore of non-uniform diameter extending therethrough; and
a locking clip located in the clip sleeve, the locking clip having an outer diameter that is smaller at one end of the locking clip than at the other end, the locking clip having a generally open-ended, cage-like shape configured to receive a cable therethrough, the cage-like shape being defined by a generally serpentine configuration with extensions extending from the serpentine configuration substantially parallel to a longitudinal axis of the locking clip and protrusions located in the extensions extending around an inner surface of the clip, the holes aligned with the openings at one end of the housing.

14. The cable seal lock assembly as set forth in claim 13, wherein the extensions are located at the smaller diameter end of the locking clip, and the smaller diameter end has greater inward flexibility than the larger diameter end.

15. The cable seal lock assembly as set forth in claim 13, wherein the clip sleeve extends through one of the openings in the top end of the housing, and at the other end of the clip sleeve, the bore is aligned with one of the openings in the bottom end of the housing.

16. The cable seal lock assembly as set forth in claim 15, wherein the opening in the top end that the clip sleeve extends through is larger than the openings in the bottom end.

17. The cable seal lock assembly as set forth in claim 16, wherein the clip sleeve includes an extension about the bore at the end of the clip sleeve extending out of the housing, the extension being bendable to prevent the locking clip in the bore of the clip sleeve from coming out when a cable is inserted therethrough.

18. The cable seal lock assembly as set forth in claim 13, further including a cable sleeve located in the housing and having a bore therethrough, and ends of the bore being aligned with respective openings in the top and bottom ends of the housing.

19. The cable seal lock assembly as set forth in claim 18, wherein the cable sleeve is substantially parallel to the clip sleeve.

20. The cable seal lock assembly as set forth in claim 18, further including a backing plate located in the housing between the bottom end and the cable sleeve and clip sleeve, the backing plate having at least two holes therethrough, the holes aligned with the openings at the bottom end of the housing.

21. The cable seal lock assembly as set forth in claim 20, wherein the backing plate is substantially perpendicular to the cable sleeve and clip sleeve.

22. A cable seal lock assembly including:
a housing, the housing having a top end and a bottom end with at least two openings in each end;
a cable sleeve located in the housing, and having a bore therethrough, and ends of the bore aligned with respective openings in the top and bottom ends of the housing;
a clip sleeve located at least partially within the housing and having a bore of non-uniform diameter extending therethrough, the bore at one end of the clip sleeve aligned with one of the openings at the bottom end of the housing;
a locking clip located in the clip sleeve, the locking clip configured to receive a cable therethrough; and
a backing plate located in the housing between the bottom end and the cable sleeve and clip sleeve, the backing plate having two holes therethrough, the holes aligned with the openings at one end of the housing and respective bores in the cable sleeve and clip sleeve.

23. The cable sleeve lock assembly as set forth in claim 22, wherein the cable sleeve and clip sleeve are substantially parallel, and the backing plate is substantially perpendicular to the cable sleeve and clip sleeve.

24. The cable sleeve lock assembly as set forth in claim 22, wherein at least one of the openings in the top end of the housing is larger than the openings in the bottom end of the housing, and the clip sleeve extends through the larger opening.

25. The cable sleeve lock assembly as set forth in claim 24, wherein the clip sleeve includes an extension about the end of the clip sleeve extending out of the housing, the extension being bendable to prevent the locking clip from coming out of the bore of the clip sleeve when a cable is inserted therethrough.

26. The cable sleeve lock assembly as set forth in claim 22, wherein the locking clip has a generally serpentine configuration and extensions extending from the serpentine configuration substantially parallel to a longitudinal axis of the clip, and protrusions around the inner surface of the locking clip are located in the extensions.

27. The cable sleeve lock assembly as set forth in claim 26, wherein the end of the locking clip having the extensions is more inwardly flexible than the other end.
